(19) United States
(12) Patent Application Publication
(10) Pub. No.: US 2009/0155430 A1
(43) Pub. Date: Jun. 18, 2009

(54) FILMS COMPRISING LIQUID SMOKE AND FLAVORANTS

(75) Inventors: I-HWA LEE, WILMINGTON, DE (US); LLOYD C. WALLENSLAGER, JR., WATERFORD, WI (US); JOHN D. VANSANT, AVONDALE, PA (US); JAMES P. KANE, JR., WILMINGTON, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/330,059

(22) Filed: Dec. 8, 2008

Related U.S. Application Data
(60) Provisional application No. 61/013,977, filed on Dec. 14, 2007.

(51) Int. Cl. A22C 13/00; B05D 7/24

(52) U.S. Cl. 426/284; 427/372.2; 427/384

(57) ABSTRACT

A process for producing a film having incorporated or applied thereon or therein an additive such as liquid smoke is provided wherein the film comprises a liquid absorbent layer and an impermeable layer. The films can be used for producing a tubular casing or shrinkbag.

This application claims the benefit of U.S. Provisional Application No. 61/013,977, filed Dec. 14, 2007, which is incorporated herein by reference in its entirety.

### FIELD OF THE INVENTION

This invention relates to process for producing a laminate film useful in packaging and/or for encasing foodstuffs.

### BACKGROUND OF THE INVENTION

Foodstuff casings are made either of natural material such as cellulose or animal guts or of synthetic material such as fibers. Foodstuff is packed into the casing. When smoked products are desired, the encased foodstuff can be further subjected to treatments such as smoking processes wherein the product is suspended in a chamber where exposure to hot smoke from burning wood occurs. In processes wherein liquid smoke is employed, the liquid smoke may be applied to the surface of the food product by showering, atomizing or spraying.

There are disadvantages related to use of cellulose and fibrous casings in smoking processes. After hours of cooking at elevated temperatures, smoke ovens are difficult to clean, sanitation and maintenance are expensive, soot and meat renderings baked on nearly every surface inside the oven necessitate cleaning to remove harmful bacteria and to provide for proper oven operation.

Liquid smoke tends to be corrosive and, if not applied properly, may cause inconsistent color and flavor and a good quantity of the liquid smoke is lost.

The permeability of cellulose or fibrous casings, while excellent for smoking of meat, provides poor barrier properties and, therefore, the smoked product must be removed from the casing and repackaged into a barrier film for extended shelf life during distribution. High permeability of the casings may cause product yield loss, and as much as 15 w% of a meat product can be lost during the cooking process.

Also, manufacturing processes for fibrous and cellulose casings involve emissions of carbon disulfide and hydrogen sulfide to the atmosphere. This is regarded as unsustainable and damaging, or unfriendly, to the environment.

Different approaches to overcome these problems include the use of single and multilayer plastic casings for packaging sausages. These generally involve the use of polyamide-based casings that are impermeable and not smokeable. Some recent developments have rendered these polyamide-based casings more smokeable by blending in absorptive polymers. Such techniques are disclosed for example in WO02/054878, U.S. Pat. No. 5,382,391, U.S. Pat. No. 5,716,656, and U.S. Pat. No. 6,200,613B1.

Barrier casings containing liquid smoke are also known in the art. PVDC coated-fibrous casings have traditionally been coated with liquid smoke on the inside of the casing. U.S. Pat. No. 6,200,613 discloses a food barrier casing comprising an absorbent inner layer connected to an impermeable foil, where the inner layer comprises fibers such as cotton, cellulose or viscose fibers, impregnated with coloring or flavoring agents.

Unlike permeable casings, in which liquid smoke permeates through the casing, liquid smoke is applied to impermeable casings in different ways. For example, WO2004/068951 discloses polymer pellets that are microporous. The polymer is ready for use when evaporation of water under these conditions leads to a 3 wt % of water content in the pellets. The polymer pellets, loaded with liquid smoke, are mixed and extruded with a compatible base polymer to provide the food casing.

A method of coating a shirred casing strand with liquid smoke, where pressure is applied to the liquid smoke forcing the smoke solution to flow between the pleats and folds of the shirred casing is disclosed in U.S. Pat. No. 4,504,500. Liquid smoke may be applied by a spray tube, by a liquid bath along which the inner wall of the casing slides, or by a liquid bubble conveyed through the casing. U.S. Pat. No. 7,022,357B2 discloses a method of preparing smoke-impregnated tubular casings by slug coating the interior surface of the casing and allowing the mixture to remain in contact with the interior surface of the casing for at least 5 days before applying a water-in-oil emulsion to the exterior surface. US2004/0247752 A1 discloses a seamless tubular food casing where at least one layer comprises a mixture including a thermoplastic starch or its derivative. The coloring or aroma is applied to this layer, followed by the casing being reversed by techniques known in the art, such that the coated layer is in the interior of the casing. WO97/3678 discloses a film article in the form of a flat sheet or tube that can be immersed in a bath of the modifier solution and adsorbing or absorbing a modifier into a food contact layer by coating the modifier solution. WO98/31731 discloses a film product wherein the food additive is combined with a binder and crosslinking agent and the crosslinked food additive layer is applied onto the film.

There may be difficulties associated with applying liquid smoke to tubular polymeric casings. The combination of an impermeable outer layer of a barrier casing with an absorptive inner layer may prevent complete permeation of the aqueous component of the additive causing sticking and blocking of the casing and an uneven distribution of the additive.

There may also be difficulties associated with applying liquid smoke to flat films. Methods using coating or printing technologies such as with a doctor blade, gravure, or knife over roll may be accomplished easily on a bench or laboratory scale but running the processes at commercially viable rates while ensuring consistent coating and adequate drying of liquid smoke without priming or use of crosslinking agents remains extremely challenging.

Tubular casings, whether made of cellulose or polymeric resins, are typically cut into about 100 to about 400 foot lengths and then shirred into short sticks that are used on food stuffing lines. New shirred sticks must be attached to the line every 3 minutes, causing frequent line stoppages as sticks are changed, and requiring a high level of manual intervention. It would be highly desirable to provide a smoke-coated flat film that can be formed, filled and sealed directly in the food stuffing line that would eliminate the need for frequent changes.

It is therefore desirable to provide a process by which liquid smoke may be applied to impermeable barrier casings with an absorptive inner layer and to provide a liquid additive coated film that can be subsequently transformed into a tubular film or shrinkable tubular film.

### SUMMARY OF THE INVENTION

The present invention is directed to a process for coating or applying a fluid additive onto or into a flat film comprising an absorptive polymer comprising, consisting essentially of, or consisting of the steps of placing a fluid additive into a container equipped with a moving gravure roll; picking up the additive from the container with the gravure roll and delivering the additive into or onto the flat film containing an absorptive polymer wherein the fluid additive includes a flavorant, a colorant, or combinations of two or more thereof.

The film can comprise, consist essentially of, consist of, or be produced from a liquid absorptive inner layer and an outer impermeable barrier layer. The barrier layer can comprise, consist essentially of, consist of, or be produced from at least one polyamide, ethylene vinyl alcohol copolymer, polyvinylidene chloride, polyolefin, or combinations of two or more thereof.

Also disclosed is a shrink film which can be adhesively laminated either prior to, during, or subsequent to the process.

### DETAILED DESCRIPTION OF THE INVENTION

Fluids can include liquids, semi-liquids, semi-gels, solutions, dispersions, emulsions, suspensions, or combinations of two or more thereof.

A flavorant is a material that provides a combination of the chemical sensations of taste and smell. It is synonymous with fragrance or flavor. Flavorant industry refers to that industry that manufactures or is concerned with edible chemicals and extracts that impart the flavor of food or food products. Flavorants can include natural or synthetic flavorants. Natural flavorants include essential oils, oleoresins, essences or extractives, protein hydrolysates, distillates, or any product of roasting, heating or enzymolysis which contains flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof. The constituents of the flavorant may be in the form of particles or pieces, for example as a mixture of solid particulate constituents used as a spice rub to flavor meat. A flavorant can also comprise constituents comprising solid particles, pieces or extracts of apple, cinnamon, curry, garlic, ginger, honey, mustard, onion, pepper, or combinations of two or more thereof, referred to herein as flavorant. These materials may also be referred to as flavors, such as, for example, apple flavor, cinnamon flavor and the like. A flavorant can further comprise constituents that impart the taste of food that is baked, barbequed, broiled, grilled, fried, roasted, rotisserie, or combinations of two or more thereof. Artificial flavorants include chemically synthesized compounds that are used to flavor food items but do not meet the specifications listed above. Artificial flavorants are often formulated with the same chemical compounds found in natural flavorants.

A colorant is a material added to food or food product to cause a change in color and can include dyes, pigments, and combinations thereof. Food colorants include anthocyanins, annatto, betaine, caramel, paprika, turmeric, chlorella, cochineal, artificial colorants, or combinations of two or more thereof.

Of note is a liquid flavorant or colorant that is more convenient for application to a flat film such as a smoke casing. Liquid flavorants can include a liquid smoke which is used to add a smoky flavor, similar to that which is obtained when cooking over an open wood fire. Liquid additives may contain a variety of coloring and flavoring compounds that may vary to yield high coloring and/or high flavoring versions. Liquid smoke is a complex mixture of solid materials and/or water-soluble materials. The most prominent of these are phenolics, carbonyl compounds, and acetic and formic acids. Liquid smoke can be produced by burning wood chips to produce smoke particles followed by condensation of the smoke particles with water or solvent into a liquid form. Woods and plant materials commonly used for producing smoke particles include beech, hickory, mesquite, oak, pecan, alder, maple, apple, cherry, plum, or combinations of two or more thereof. The liquid is then scrubbed and filtered to remove all impurities. The apparatus and methods of manufacturing typical liquid smokes are described in U.S. Pat. No. 3,106,473 and U.S. Pat. No. 3,873,741, for instance. The liquid flavorant may be added to sauces and marinades to flavor meat, poultry, and seafood.

Liquid smoke products are available in a broad spectrum of pH levels from about 2 to about 12 or about 2.5 to about 7. Some methods of neutralizing acidic liquid smokes are described in U.S. Pat. No. 4,104,408 and U.S. Pat. No. 4446167. Liquid smokes may be further modified to include oils, thickeners and emulsifiers, as described for example in U.S. Pat. No. 5,690,977.

Liquid smoke can be further diluted with one or more liquids including water, solvent, or combinations thereof. The solvent can include alcohols such as ethanol, propanol, isopropanol, propylene glycol, butanol, an alkene diol, or combinations of two or more thereof. The alkene diol is preferably 1,2-propane diol. Liquid smoke can be diluted with water to a moisture content of from about 35% to about 90% or about 50% to about 80%. An alcohol, such as ethanol, propanol, isopropanol, or butanol, or an emulsifier, such as polyoxyethylene (20) sorbitan monooleate, commercially known as Polysorbate® 80 or Tween® 80 (obtained from Croda International), may be incorporated to add stability to the diluted solution.

Liquid smoke coating weights on the film substrate, of from about 3 g/m² to about 45 g/m² or about 10 g/m² to about 25 g/m², cover a range of coating values which will impact the interaction of the liquid smoke with the encased foodstuffs in order to obtain either flavor or color or a combination of both.

Examples of foodstuffs that can be processed and packaged include beef, pork, poultry (e.g., chicken and turkey), seafood (e.g., fish and mollusks) and dairy (such as cheese), or combinations of two or more thereof. Meat products include, but are not limited to, sausages, lunchmeats, hams, turkey logs or rolls, chicken logs or rolls, hot dogs, and kielbasa. Meat products can be whole-muscle, formulated into various meat slurries, formed into shapes, or ground. Formed or ground meat can optionally be a mixture of material derived from more than one species.

The additive may be aqueous-based and may contain acids and bases. It can also be diluted with a solvent such as alcohol including ethanol, isopropyl alcohol, acetone, methyl ethyl ketone, or combinations of two or more thereof to facilitate drying or curing.

Liquid additives used in the practice of the invention can be applied to a film having an absorptive layer as follows. In practice, the additive is placed in a container such as a trough (or any other suitable container, generally one equipped with a gravure roll mounted therein). A moving gravure roll is used to pick up the additive. The gravure roll may have cavities or pockets engraved with any desired forms and depth. The gravure roll may also contain a cylinder comprising etched cells of specific dimensions to pick up and deliver the liquid additive. The etched cells may be quadrangular, tri-helical, pyramidal, channeled, or combinations of two or more of these shapes. The depth and number of cells can be chosen to accommodate the solids ratio of the liquid to be coated and the desired coating depth, which can be from about 0.0001 to about 1 or about 0.0001 to about 0.05 inch, applied to the film.

The rolls can be engraved using any conventional, commercial engraving techniques such as, for example, an acid etching process or engraving technique.

Back up rolls are generally used to contact the films to be coated (or the coated films) onto the gravure rolls. Typically the back up rolls are made of silicone rubber of varying hardness as needed; and the backup roll width should be sized to be about 5 to 15 mm less than the coating width desired. Nip roll pressures can be adjusted to provide adequate pressure in order to remove the liquid coating from the gravure roll to imprint the film. The gravure and back up rolls can be at any ambient temperature such as about 10° C. to about 50° C.

A scraper, for example including a knife, blade, or any scraping device, such as doctor blades, can be positioned against the rolls to provide even application, especially when a thin film coating of the additive is desired to be applied onto the surface of a casing. Appropriate pressure can also be applied by an impression roll, with or without scraper, to the coating.

The application (coating) speed can be between about 5 to about 500 feet per minute (ft/m), or about 50 to about 350 ft/m. The film, coated with additive, can be cured, e.g., by drying in a heated forced air current in a drying tunnel. Such drying tunnels may also be equipped with infrared heaters. When heat curing is employed, the temperature on the surface of the coated film can be from about 40 to about 150 or about 50 to about 120° C., depending on the nature of the additive.

Coatings may be applied in thicknesses of about 0.01 mil to about 2 mil or about 0.1 mil to about 1 mil (1 mil=25.4 μm) thick. The coated film may be slit online to various widths before being taken up on wind up rolls.

An absorptive inner layer is a layer that comes into direct contact with foodstuff placed inside a casing. An outer layer is the layer farthest from the foodstuff. Absorptive inner layers are useful for imparting flavor and color evenly to food such as meat during cooking.

The inner layer of the films disclosed herein is a liquid absorptive layer and can comprise or be produced from a polymer including block copolyetherester polymers, block copolyetheramide polymers, or combinations thereof. The outer layer can be an impermeable barrier layer. The inner layer and the outer layer can be a single film layer, or a laminate or multilayer film comprising or produced from at least one polymer layer and optionally at least one tie layer.

The inner layer can have a moisture vapor transmission rate (MVTR) of at least about 1200 g·25 μ/m²·24 hrs, or from about 1200 to about 20000 g·25 μ/m²·24 hrs at 38° C., 100% humidity.

Polymers used in an absorptive layer can be hydrophilic and hygroscopic. A copolyetherester is a thermoplastic polymer and can have a viscosity in the range of from about 20 pascal seconds (Pa·s) to about 3000 Pa·s, about 40 to about 1000 Pa·s, or about 50 to about 700 Pa·s, as determined according to standard method ISO11443.

Copolyetheresters include one or more copolymers having a multiplicity of recurring long-chain ester units and short-chain ester units joined head-to-tail through ester linkages. The long-chain ester unit comprises repeat units of —OGO—C(O)RC(O)— and the short chain ester unit comprises repeat units of —OGO—C(O)RC(O)—. G is a divalent radical remaining after the removal of terminal hydroxyl groups from poly(alkylene oxide)glycols having a number average molecular weight of between about 400 and about 6000, or preferably between about 400 and about 3000. R is a divalent radical remaining after removal of carboxyl groups from a dicarboxylic acid having a molecular weight of less than about 300. D is a divalent radical remaining after removal of hydroxyl groups from a diol having a molecular weight less than about 250.

The copolyetherester preferably contains about 15 to about 99 weight % short-chain ester units and about 1 to about 85 weight % long-chain ester units, or from about 25 to about 90 weight % short-chain ester units and about 10 to about 75 weight % long-chain ester units.

Such copolyetheresters are disclosed in US patents including U.S. Pat. No. 3,651,014, U.S. Pat. No. 3,766,146, and U.S. Pat. No. 3,763,109. A commercially available copolyetherester is Hytrel® from E. I. du Pont de Nemours and Company (DuPont). Others include Arnitel® from DSM in the Netherlands and Riteflex® from Ticona, USA.

An example of copolyetherester comprises a long chain ester having copolymerized units of an ethylene oxide/propylene oxide copolyether glycol having a molecular weight of about 1800 to about 2500 or about 2150.

The absorptive layer in the film may also comprise block copolyetheramides. Such block copolyetheramides can comprise or consist of crystalline polyamide and noncrystalline polyether blocks. Polyamides may be nylon 6 or nylon 12.

Copolyetheramides are also well known in the art as disclosed in U.S. Pat. No. 4,331,786. They comprise a linear and regular chain of rigid polyamide segments and flexible polyether segments, as represented by the formula HO—[C(O)PAC(O)OPEO]ₙ—H where PA is a linear saturated aliphatic polyamide sequence formed from a lactam or amino acid having a hydrocarbon chain containing 4 to 14 carbon atoms or from an aliphatic C₆-C₉ diamine, in the presence of a chain-limiting aliphatic carboxylic diacid having 4-20 carbon atoms. The polyamide has an average molecular weight between 300 and 15,000. PE is a polyoxyalkylene sequence formed from one or more linear or branched aliphatic polyoxyalkylene glycols or copolyethers derived therefrom said polyoxyalkylene glycols having a molecular weight of less than or equal to 6000. The subscript n indicates a number of repeat units so that the polyetheramide copolymer has an intrinsic viscosity of from about 0.8 to about 2.05. The process for producing the polyetheramide is well-known and is disclosed for example in U.S. Pat. No. 6,815,480. A commercially available series of polyetheramides is available under the tradename “Pebax®” from Atofina.

The outer barrier (impermeable) layer of the films described herein can be a single film layer, a laminate or multilayer film. The barrier layer comprises or is produced from at least one polymer including polyamides, ethylene vinyl alcohol copolymers (EVOH), polyvinylidene chloride, polyolefins, or combinations of two or more thereof. The layer optionally comprises an adhesive layer, useful as a tie layer between any two non-compatible layers in a laminated outer barrier layer. Examples of multilayer barrier structures include, from outermost layer to innermost layer: polyethylene/tie layer/polyamide; polyethylene/tie layer/polyamide/tie layer/polyethylene; polypropylene/tie layer/polyamide/EVOH/polyamide; polyamide/tie layer/polyethylene; polyamide/tie layer/polyethylene/tie layer/polyamide; polyamide/tie layer/polyamide/EVOH/polyamide. Depending on the nature of the innermost layer of the impermeable structure, an additional inner tie layer can be interposed between the impermeable structure and the absorptive layer to provide a desirable level of adhesion to the absorptive layer.

The layer can provide effective barriers to moisture and oxygen and bulk mechanical properties suitable for processing and/or packaging the foodstuff, such as clarity, toughness and puncture-resistance. For smoking and/or cooking processes, shrink properties can be desirable.

Polyamides include aliphatic polyamides, amorphous polyamides, or combinations thereof. Aliphatic polyamides can refer to aliphatic polyamides, aliphatic copolyamides, and blends or mixtures of these such as polyamide 6, polyamide 6.66, blends and mixtures thereof. Polyamides 6.66 are commercially available under the tradenames “Ultramid C4” and “Ultramid C35” from BASF, or under the tradename “Ube5033FXD27” from Ube Industries Ltd. Polyamide 6 is commercially available under the tradename Nylon 4.12 from DuPont.

The aliphatic polyamide may have a viscosity ranging from about 140 to about 270 cubic centimeters per gram (cm³/g) measured according to ISO307 at 0.5% in 96% H₂SO₄.

The film may further comprise other polyamides such as those disclosed in U.S. Pat. Nos. 5,773,059; 5,408,000; 4,174,358; 3,393,210; 2,512,606; 2,312,966 and 2,241,322. The film may also comprise partially aromatic polyamides, which can comprises repeat units derived from —HN—(CH₂)ₘ—CO— or the combination of —HN—(CH₂)ₙ—CO—, —HN—(CH₂)ₙ—NH—, and —CO—(CH₂)ₙ—CO— wherein m and n are each independently from about 5 to about 11. When used together with a polyamide, partially aromatic polyamides can be present, based on the total polymer weight, in amounts of about 5 to about 50%. Such polyamides can include amorphous nylon resins 6-I/6-T commercially available under the tradename Selar® PA from DuPont or commercially available under the tradename Grivory® G 21 from EMS-Chemie AG.

EVOH having from about 20 to about 50 mole % ethylene can be suitable such as those under the tradename Evalca® from Kuraray or Noltex® from Nippon Goshei. Polyvinylidene chloride (PVDC) can be obtained commercially from Dow Chemical under the tradename Saran®.

Polyvinylidene chloride (PVDC) is a well known polymer derived from vinylidene chloride. PVDC has a very low permeability to moisture and other gases and is resistant to chemicals and solvents. It is available commercially from Dow Chemical.

Polyolefins include polypropylenes, polyethylene polymers and copolymers. Polyethylenes can be prepared by a variety of methods, including the well-known Ziegler-Natta catalyst polymerization (see e.g., U.S. Pat. Nos. 4,076,698 and 3,645,992), metallocene catalyst polymerization (see e.g., U.S. Pat. Nos. 5,198,401 and 5,405,922) and by free radical polymerization. Polyethylenes can include linear polyethylenes such as high density polyethylene (HDPE), linear low density polyethylene (LLDPE), very low or ultralow density polyethylenes (VLDPE or ULDPE) and branched polyethylenes such as low density polyethylene (LDPE). The densities of polyethylenes suitable for use in the present invention range from 0.865 g/cc to 0.970 g/cc. Linear polyethylenes can incorporate a-olefin comonomers such as butene, hexene or octene to decrease density within the density range. The impermeable layer can comprise ethylene copolymers such as ethylene vinyl esters, ethylene alkyl acrylates, ethylene acid dipolymers, ethylene acid terpolymers and their ionomers. Examples of such ethylene copolymers are ethylene vinyl acetate, ethylene methyl acrylate and ethylene(meth)acrylic acid polymers and their ionomers. Polypropylene polymers useful in the practice of the present invention include propylene homopolymers, impact modified polypropylene and copolymers of propylene and alpha-olefins and their blends.

The adhesive layer (tie layer) can comprise anhydride-modified ethylene homopolymers, anhydride-modified ethylene copolymers, and/or any others known to one skilled in the art.

Anhydride or acid-modified ethylene and propylene homo- and co-polymers can be used as extrudable adhesive layers to improve bonding of layers of polymers together when the polymers do not adhere well to each other, thus improving the layer-to-layer adhesion in a multilayer structure. The compositions of the tie layers can be determined according to the compositions of the adjoining layers that need to be bonded in a multilayer structure. One skilled in the polymer art can select the appropriate tie layer based on the other materials used in the structure. Various tie layer compositions are commercially available under the trademark Bynel® from DuPont.

Impermeable films can additionally comprise one or more additives used in polymer films including plasticizers, stabilizers, antioxidants, ultraviolet ray absorbers, hydrolytic stabilizers, anti-static agents, dyes or pigments, fillers, fire-retardants, lubricants, reinforcing agents such as glass fiber and flakes, processing aids, antiblock agents, release agents, and/or mixtures thereof.

Polymer can be converted into a film by various techniques. For example, a laminate film can be obtained by coextrusion as follows: granulates of the various components can be melted in extruders; the molten polymers passed through a die or set of dies to form layers of molten polymers that are then processed as a laminar flow. The molten polymers can be cooled to form a layered structure. Other suitable techniques include blown film extrusion, cast film extrusion, cast sheet extrusion and extrusion coating. The impermeable barrier film disclosed herein can be a coextruded tubular film obtained by a blown film extrusion process. The impermeable barrier film can be a coextruded flat film made by a cast film process. Both tubular and flat films may be further slit to obtain flat films of desired widths. The coextruded films can be further oriented beyond the immediate quenching or casting of the film. The process can comprise coextruding a multilayer laminar flow of molten polymers, quenching the coextrudate and orienting the well-quenched coextrudate in at least one direction. “Well-quenched” means an extrudate that has been substantially cooled below its melting point in order to obtain a solid film.

The film may be uniaxially oriented, or biaxially oriented by drawing in two mutually perpendicular directions in the plane of the film to achieve a satisfactory combination of mechanical and physical properties.

Orientation and stretching apparatus to uniaxially or biaxially stretch film are known in the art and may be adapted by those skilled in the art to produce films of the present invention. Examples of such apparatus and processes include, for example, those disclosed in U.S. Pat. Nos. 3,278,663; 3,337,665; 3,456,044; 4,590,106; 4,760,116; 4,769,421; 4,797,235 and 4,886,634.

The processing necessary to obtain an oriented blown film is known in the art as a double bubble technique, and can be carried out as disclosed in U.S. Pat. No. 3,456,044. For example, a primary tube is melt extruded from an annular die. This extruded primary tube is cooled quickly to minimize crystallization. It is then heated to its orientation temperature (e.g., by means of a water bath). In the orientation zone of the film fabrication unit a secondary tube is formed by inflation, thereby radially expanding the film in the transverse direction as it is pulled or stretched in the machine direction at a temperature such that expansion occurs in both directions, perhaps simultaneously; the expansion of the tubing being accompanied by a sharp, sudden reduction of thickness at the draw point. The tubular film is then again flattened through nip rolls. The film can be reinflated and passed through an annealing step (thermofixation), during which step it is heated once more to adjust the shrink properties. For preparation of food casings (e.g., sausage casings, shrink bags) it may be desirable to maintain the film in a tubular form. For preparing flat films the tubular film can be slit along its length and opened up into flat sheets that can be rolled and/or further processed.

The impermeable outer layer with the absorptive inner layer (film) may be laminated on the surface away from (i.e. opposite from) the absorptive layer to a shrink film if so desired, by adhesive lamination processes known in the art using water-based, solvent or solventless adhesives. The shrink film may be laminated to the impermeable film with the absorptive inner layer, for example prior to coating with an additive such as liquid smoke or after coating with an additive such as liquid smoke, as is expedient. The shrink film may also be laminated such that it protrudes from the film edge of the impermeable film with the absorptive inner layer by a width of 10 to 50 mm in order to provide a sealing edge strip during the food-stuffing operation.

The invention also includes a tubular casing or shrinkbag or thermoformable pouch comprising a film that comprises or is produced from the film disclosed above in which the inner layer is an absorptive layer.

The above described film may be used in a form-fill-seal application. In this manner, the roll of film passes along, over, and around a forming shoulder to form a tube with overlapping edges. The formed tube then travels through a longitudinal sealing station wherein the overlapping edges are sealed, typically via a thermal process. There may be a short cooling and gathering station following sealing. Following this, the thus-formed tube passes over the exterior of the stuffing horn. Concentric to the interior of the forming shoulder is a tube conveying a foodstuff through these processes, which connects to the stuffing horn. A short portion of the formed tube is drawn off the end of the stuffing horn and closed, typically with a metal clip. The filling operation commences wherein the foodstuff exits the stuffing horn, fills the formed tube, and draws additional film off the stuffing horn. At a predetermined interval, such as about 30 to about 72 inches, the filling operation pauses, about 1 to about 2 inches of formed tube is drawn off the end of the stuffing horn and collapsed, and closures (e.g., metal clips) are placed around the collapsed formed tube. The collapsed tube is severed between the adjoining closures, and the foodstuff filled log exits the operation, and the cycle of filling of the next log begins. This process is more fully described in U.S. Pat. No. 6,146,261.

The following Examples are merely illustrative and are not to be construed as to limit the scope of the invention.

### EXAMPLES 1-3

The absorptive layers of the coextruded films of the examples are Polymer A (melting point 200° C.) and Polymer B (melting point 200° C.) shown in Table A, each of which is a copolyetherester.

TABLE A

| Example | Comonomer Content of Polymer |
|---|---|
| Polymer A | 45 wt. % 1,4-butylene terephthalate, 55 wt. % ethylene |
| | oxide/propylene oxide copolyether terephthalate. Calculated |
| | ethylene oxide content of 33%. |
| Polymer B | 42 wt. % 1,4-butylene terephthalate, 12 wt. % 1,4-butylene |
| | isophthalate, 36 wt. % ethylene oxide/propylene oxide |
| | copolyether terephthalate, 10 w % ethylene oxide/propylene |
| | oxide copolyether isophterephthalate. Calculated ethylene |
| | oxide content of 13%. |

Approximately 68 inches by 12 inches of three-layer coextruded films of Capron B73WZP nylon 6/Bynel® 21E787/Polymer A with respective layer thicknesses of 25 μm, 12 μm and 23 μm were taped onto the surface of a roll of oriented polyester (Mylar® 48 LBT). The film roll was placed in contact with a 26 inch wide, 35 quad gravure roll with a doctor blade in place. The gravure roll was positioned in a trough containing liquid smoke (pH approximately 3, total acidity as acetic acid 7 to 10 weight %, smoke flavor compounds 30 to 40 mg/ml, carbonyls content 40 to 50 weight % and density approximately 10 lbs/gal). The pressure between the gravure roll and a 20 inch backup roll was 50 psi, and the line speed for coating the film by the rotating gravure roll was 3 ft/m. The coated films produced by this process were conducted to a 15 foot drying tunnel set at the temperatures shown in Table 1. On exiting the tunnel, the coated film was wound up on a roll. Portions of the coated film were treated using this liquid smoke coating process in a second and third pass as shown in Table 1. The liquid smoke coated coextruded films were then adhered using tape onto 50 inch long sections of 45 μm tubular film having the following layer structure: nylon/tie/PE/tie/nylon. The thus-produced laminates were inverted so that the liquid smoke coated surfaces were in the interior of the tube. The casings were then stuffed with ham (90% lean ham trimmings) and cooked in a standard step steam cooking cycle:

| | | |
|---|---|---|
| Step 1, 140° F. dry bulb | 140° F. wet bulb | 60 minutes |
| Step 2, 150° F. dry bulb | 150° F. wet bulb | 60 minutes |
| Step 3, 160° F. dry bulb | 160° F. wet bulb | 60 minutes |
| Step 4, 175° F. dry bulb | 175° F. wet bulb | to internal |
| Step 5, cold shower 30 minutes | | |

After cooling overnight in a refrigerated room at 40° F., the casings were stripped and the hams assessed for smoke color and evenness of coating with liquid smoke.

TABLE 1

| | | | Smoke | |
|---|---|---|---|---|
| | Tunnel | | Coating | |
| | Temp | | Gauge | Ham Color Assessment |
| Example | (° F.) | # Passes | (mil) | after Cooking |
| 1 | 200 | 1 | 0.5-0.7 | Fully developed smoke |
| | | | | color; even throughout |
| 2 | 220 | 2 | 1-1.1 | Very dark smoke color, |
| | | | | even throughout |
| 3 | 220 | 3 | 1.6 | Very dark smoke color, |
| | | | | similar to Example 2 |

### EXAMPLES 4 AND 5

A five-layer coextruded blown film having the following layer structure was prepared:
LLDPE (Dowlex 2045G)/Bynel® 4104/nylon 6(Ultramid B35F)/Bynel® 21E787/Polymer A with a layer distribution of 15/10/20/10/25 μm, respectively. A 510 mm wide sample of this film was thermally laminated onto a 535 mm oriented polyester film of Mylar® RL (Example 4 film).

A five-layer coextruded blown film having the following layer structure was prepared:
LLDPE (Dowlex 2045G)/Bynel®4104/nylon 6(Ultramid B35F)/Bynel® 21E787/Polymer A with a layer distribution of 22/10/20/10/18 μm. A 510 mm wide sample of this film was adhesively laminated onto a 535 mm 50 micron polyethylene/polyamide/polyethylene shrink film. (Example 5 film).

The Example 4 and 5 films were then coated with liquid smoke in a process similar to that described above for Examples 1-3, using the tunnel drying temperatures shown in Table 2. The smoke-coated films were sealed into 10 ft tubes, stuffed with a ham formulation and cooked under the conditions described for Examples 1-3. The results are described in Table 2.

TABLE 2

| | Tunnel | | |
|---|---|---|---|
| | Temp | | |
| Example | (° F.) | # Passes | Ham Color Assessment after Cooking |
| 4 | 220 | 1 | Uniform smoke color with no dark area |
| 5 | 215 | 1 | Uniform smoke color with no dark area |

### EXAMPLE 6

A five-layer blown film having the following layer structure:
polypropylene/Bynel® 50E725/Nylon6/Bynel® 21E787/Polymer A having layer thicknesses of 8/3/8/6/18μ respectively and a 1050 mm width is passed between a 1020 mm rubber back up roll and a 44 quad gravure roll, with the doctor blade on. The gravure roll is set in a trough containing 15% ethanol and 85% liquid smoke (pH approximately 3.0, total acidity as acetic acid 7 to 10 weight %, smoke flavor compounds 30 to 40 mg/ml, carbonyls content 40 to 50 weight % and density approximately 10 lbs/gal). The liquid smoke coating line speed is 120 ft/min. After being coated the film is dried by passing through a hot air tunnel. The air tunnel heat temperatures are set at 250° F. (121° C.), 350° F. (177° C.), 350° F. (127° C.), 400° F. (204° C.) in four zones. The liquid smoke coating weight of the film is 18 g/square meter. The coated film is then slit down to a 1020 mm width and adhesively laminated to 1070 mm wide 47 micron polyethylene/polyamide/polyethylene shrink film at 300 ft/min using a laminating adhesive, so that 25 mm width of the shrink film protrudes from each edge of the smoke-coated film. The film composite is then slit into 535 mm wide rolls and then converted to 15-inch tubular casing lengths on a sealer. The casings are then stuffed with ham (90% lean ham trimmings) and cooked in a standard step steam cooking cycle as disclosed in Examples 1-3. After cooling overnight in a refrigerated room at 40° F, the casings are stripped. Ham logs prepared by this process have excellent and uniform smoke color.

### EXAMPLES 7-10

Five layer coextruded cast films were produced on a 4 extruder Sano cast film line.

A first film (Example 7 film) had the following layer structure: low density polyethylene(LDPE) (DuPont LDPE1640)/Bynel® 21E787/Nylon 6 (Capron® B73WP)/Bynel® 21E787/Polymer A. Layer thicknesses were 13/5/8/5/20 μm respectively. Polymer A was further modified by treatment with 6 weight % of Conpol® 20T, a talc-based concentrate from DuPont.

A second film (Example 8 film) had the following layer structure: LDPE (DuPont LDPE1640)/Bynel® 21E787/Nylon 6 (Capron® B73WP)/Bynel® 21E787/Polymer A. Layer thicknesses were 21/5/8/5/12 μm respectively. Polymer A was further modified by treatment with 6 weight % of Conpol® 20T, a talc-based concentrate from DuPont.

A third film (Example 9 film) had the following layer structure: LDPE (DuPont LDPE1640)/Bynel® 21E787/Nylon 6 (Capron® B73WP)/Bynel® 21E787/Polymer B. Layer thicknesses were 13/5/8/5/20 μm respectively. Polymer B was further modified by treatment with 6 weight % of Conpol® 20T, a talc-based concentrate from DuPont.

A fourth film (Example 10 film) had the following layer structure: LDPE (DuPont LDPE1640)/Bynel® 21E787/Nylon 6 (Capron® B73WP)/Bynel® 21E787/Polymer B. Layer thicknesses were 21/5/8/5/12 μm respectively. Polymer B was further modified with 6 weight % of Conpol® 20T, a talc-based concentrate from DuPont.

The films of these examples were slit to a width of 460 mm and adhesively laminated onto 510 mm oriented polyester film of Mylar® 48 LBT. The example films were then coated with liquid smoke in a process similar to that used in above-described Examples 1-3, except that the liquid smoke was diluted with 20 wt % isopropyl alcohol. The back up roll was 17.5 inches, and the drying tunnel temperature was set at 230° F. The liquid smoke-coated films were sealed into 10 ft tube lengths, stuffed with a ham formulation and cooked under the conditions described in Examples 1-3. The results showed acceptable and uniform color for the Example 7-10 films and indicated both absorptive polymers A and B give uniform color at layer thicknesses of 12 and 20 μm.

### EXAMPLES 11-13

Five-layer coextruded blown films were produced on a 7-extruder Brampton blown film line.

A first film (Example 11 film) had the following layer structure: Polyproplene homopolymer (“HomoPP”; Fina 3365)/Bynel® 50E725/Nylon 6(Ultramid B40-01)/Bynel® 21E787/Polymer A. The layer thicknesses were respectively 8/7/8/7/20 μm. Polymer A was further modified by treatment with 6 weight % of Conpol® 20T, a talc-based concentrate from DuPont.

A second film (Example 12 film) had the following layer structure: HomoPP (Fina 3365)/Bynel® 50E725/Nylon 6(Ultramid B40-01)/Bynel® 21E787/Polymer B. The layer thicknesses were respectively 8/7/8/7/20 μm. Polymer B was further modified by treatment with 6 weight of Conpol® 20T, a talc-based concentrate from DuPont.

A third film (Example 13 film) had the following layer structure: Nylon 6-Nylon66 (80/20 blend)/ Nylon 6(Ultramid B40-01)/Bynel® 21E787/Polymer A. The layer thicknesses were respectively 8/15/7/20 μm.

The nylon 6-nylon 66 blend in the outer layer of the Example 13 film was a dry blend of 80 wt % Ultramid B40-01 and 20 w% of Zytel® 101. Polymer A was further modified by treatment with 6 weight % of Conpol® 20T, a talc-based concentrate from DuPont.

The films of examples 11 and 12 were slit to a width of 500 mm and then coated with liquid smoke in a process similar to that used in Examples 1-3, except that the liquid smoke was diluted with 20 wt % isopropyl alcohol. The back up roll was 17.5 inches, the drying tunnel temperature was set at 240° F. and the line speed was set at 10 feet/min. The liquid smoke coated Example 11 and 12 films were then slit to a width of 360 mm and adhesively laminated to 415 mm wide 55 micron polyethylene/polyamide/polyethylene shrink film. The adhesive lamination was conducted using a 110 quad cell gravure roll. The adhesive Adcote 503A (25% solids in methyl ethyl ketone) containing Catalyst F (Morton) was coated onto the shrink film using a 11.625 inch backup roll. The shrink film line speed was 20 feet/minute with the drying tunnel set at 150° F. and the hot nip nipping the shrink film to the smoke coated film set at 160° F. After adhesive lamination, the laminate films were slit to a width of approximately 390 mm, with approximately 30 mm of this width at one edge being the shrink film alone, and the remaining 360 mm of this width being the composite of shrink film and smoke coated film.

Example 11 and 12 films were also coated as described above except that in place of liquid smoke, the spice rub mixtures described in Table 3 were employed. The back up roll was 17.5 inches, the drying tunnel temperature was set at 260° F. and line speed was set at 10 feet/min. The liquid smoke coated Example 11 and 12 films were then slit to a width of 360 mm and adhesively laminated to 415 mm wide 55 micron polyethylene/polyamide/polyethylene shrink film. The adhesive lamination was conducted using a 110 quad cell gravure roll. The adhesive Adcote 503A (25% solids in methyl ethyl ketone) containing Catalyst F (Morton) was coated onto the shrink film with an 11.625 inch backup roll. The shrink film line speed was 20 feet/minute with the drying tunnel set at 150° F. and the hot nip nipping the shrink film to the smoke coated film set at 160° F. After adhesive lamination, the laminate films were slit to a width of approximately 390 mm, with approximately 30 mm of this width at one edge being the shrink film alone, and the remaining 360 mm of this width being the composite of shrink film and liquid smoke coated film.

TABLE 3

| Spice Rub | | Example |
|---|---|---|
| Mixture | Ingredients | Film |
| Spice rub 1 | 1.2 w % McCormick curry powder | 11 |
| | 1.2 w % McCormick ginger | |
| | 2.4 w % McCormick mustard | |
| | 9.4 w % isopropyl alcohol | |
| | 85.8 w % Red Arrow Maillose ™ | |
| Spice rub 2 | 3.9 w % McCormick garlic powder | 11, 12 |
| | 3.9 w % McCormick onion powder | |
| | 17.5 w % isopropyl alcohol | |
| | 74.7 w % Red Arrow Maillose ™ | |

1. A process for applying an additive onto or incorporating an additive into films comprising the steps of introducing a fluid additive into a container equipped with a moving gravure roll; picking up the additive from the container with the gravure roll; delivering the additive into or onto a flat film; drying the film; and optionally converting the flat film into a tubular film wherein
(i) the process is carried out batch-wise or continuously;
(ii) the fluid additive includes flavorant, colorant, or combinations thereof; and
(iii) the flat film comprises a liquid absorptive layer comprising or produced from a block copolyetherester comprising polyether blocks and polyester blocks, a block copolyetheramide, or combinations of two or more thereof.

2. The process of claim 1 wherein
(i) the flat film comprises or is produced from a liquid absorptive inner layer and an outer impermeable barrier layer;
(ii) the inner layer comprises or is produced from a polymer selected from the group consisting of block copolyetherester polymers, block copolyetheramide polymers, and combinations of two or more thereof; and
(iii) the barrier layer comprises at least one layer selected from the group consisting of polyamides, ethylene vinyl alcohol copolymers, polyvinylidene chloride, polyolefins, and combinations of two or more thereof.

3. The process of claim 2 wherein the barrier layer is a polyamide.

4. The process of claim 2 wherein (i) the additive is selected from the group consisting of colorants, fllavorants and combinations of two or more thereof; (ii) the colorant is selected from the group consisting of anthocyanin, annatto, betaine, caramel, paprika, turmeric, chlorella, cochineal, artificial colorant, and combinations of two or more thereof; and (iii) the additive is a flavorant selected from the group consisting of baked flavors, barbequed flavors, broiled flavors, grilled flavors, fried flavors, roasted flavors, rotisserie flavors, apple flavors, cinnamon flavors, curry flavors, garlic flavors, ginger flavors, honey flavors, mustard flavors, onion flavors, pepper flavors, or combinations of two or more thereof.

5. The process of claim 4 wherein the additive is present in a liquid comprising water, solvent, or combinations thereof.

6. The process of claim 2 wherein the additive comprises a liquid smoke comprising particles produced by burning a wood or plant material selected from the group consisting of beech, hickory, mesquite, oak, pecan, alder, maple, apple, cherry, plum, or combinations of two or more thereof.

7. The process of claim 6 wherein the additive is present in a liquid comprising water, solvent, or combinations thereof.

8. The process of claim 7 wherein the liquid is a solvent selected from the group consisting of ethanol, propanol, isopropanol, butanol, propylene glycol, and combinations of two or more thereof.

9. The process of claim 1 wherein barrier layer is a single film layer, a laminate, or a multilayer film and the flat film further comprises at least one tie layer.

10. The process of claim 8 wherein barrier layer is a single film layer, a laminate, or a multilayer film and the flat film further comprises at least one tie layer.

11. The process of claim 9 wherein the barrier layer comprises a layer comprising nylon, a layer comprising an ethylene vinyl alcohol polymer, or combinations thereof.

12. The process of claim 11 wherein the flat film comprises a polypropylene layer, a polyethylene layer, or a combination of a polyethylene layer and a polypropylene layer.

13. The process of claim 9 wherein the inner layer has a moisture vapor transmission rate of at least about 1200 g·25 μ/m²·24 hrs at 38° C., 100% humidity.

14. The process of claim 13 wherein the inner layer is a copolyether ester comprising copolymerized units of a long chain ester derived from an ethylene oxide/propylene oxide copolyether glycol having a molecular weight of about 1800 to about 2500 and has moisture vapor transmission rate of at least about 1200 to about 20000 g·25 μ/m²·24 hrs at 38° C., 100% humidity.

15. The process of claim 1 wherein the flat film is a blown film or a cast film.

16. The process of claim 15 wherein the flat film is biaxially oriented, further laminated onto a biaxially oriented film, or both.

17. The process of claim 16 wherein the biaxially oriented flat film is heat shrinkable at about 2% to about 50% in the machine direction and in the transverse direction at 85° C. to 95° C.

18. The process of claim 17 further comprising forming the flat film into a tubular film forming said tubular film into a casing.

19. The process of claim 18 further comprising introducing a foodstuff into the casing thereby forming a food product wherein the foodstuff includes beef, pork, chicken, turkey, fish, mollusk, dairy products, or combinations of two or more thereof.

20. The process of claim 19 wherein the food product comprises sausage, lunchmeat, ham, turkey log or roll, chicken log or roll, hot dog, or kielbasa.
